(19) United States
(12) Patent Application Publication
(10) Pub. No.: US 2026/0158803 A1
(43) Pub. Date: Jun. 11, 2026

(54) MEDIUM TRANSPORT DEVICE AND RECORDING DEVICE

(71) Applicant: SEIKO EPSON CORPORATION, Tokyo (JP)

(72) Inventors: Kazutoshi MATSUZAKI, SHIOJIRI-SHI (JP); Ryoichi MORISAWA, SHIOJIRI-SHI (JP)

(21) Appl. No.: 19/412,110

(22) Filed: Dec. 8, 2025

(30) Foreign Application Priority Data
Dec. 10, 2024 (JP) 2024-215049

(51) Int. Cl. B41J 13/00; B41J 13/03; B41J 13/08; B41J 29/13; B41J 29/17; B65H 3/06

(52) U.S. Cl. CPC B41J 13/009; B41J 13/03; B41J 13/08; B41J 29/13; B41J 29/17; B65H 3/06; B65H 2301/531; B65H 2404/14; B65H 2404/20

(57) ABSTRACT

A medium transport device 1 includes a switching part 100 that switches a transport direction of a medium P in a transport path and a door part 17 that is configured to be displaced between a closed state and an opened state, wherein the switching part 100 is displaced to a switching position where the switching part 100 switches the transport direction of the medium P when the door part 17 is in the closed state, and is displaced to an opening position where the switching part 100 opens the transport path when the door part 17 is in the opened state and a through hole H is formed in the switching part 100.

The present application is based on, and claims priority from JP Application Serial Number 2024-215049, filed Dec. 10, 2024, the disclosure of which is hereby incorporated by reference herein in its entirety.

### BACKGROUND

### 1. Technical Field

The present disclosure relates to a medium transport device and a recording device.

### 2. Related Art

Medium transport devices including various configurations have been used in the related art, such as in a recording device represented by a printer. Among these, there is a medium transport device including a plurality of transport paths of a medium. In a medium transport device including a plurality of transport paths, a switching section that switches the transport paths is provided. For example, JP-A-2023-60474 discloses an inkjet printer including a switching section that can switch transport paths. The switching section is configured to be able to open the transport paths in conjunction with opening of a door part.

However, in the medium transport device of the related art including a plurality of transport paths of the medium, there is a possibility that foreign matter deposited on the medium may be scattered in the device. This is because, for example, there is a case where foreign matter deposited on the medium is deposited on and accumulates on the switching section, and the foreign matter accumulated on the switching section spills in the device due to the displacement of the switching section. For example, in the inkjet printer of JP-A-2023-60474, there is a possibility that foreign matter may accumulate on the switching section that is opened by an operation of opening the door part. Then, when the switching section returns to a transport path side by an operation of closing the door part, the accumulated foreign matter may enter the transport paths.

### SUMMARY

A medium transport device of the present disclosure for overcoming the above-described problem includes a switching section that switches a transport direction of a medium in a transport path and a door part that is configured to open and close with respect to an opening section, and that is configured to be displaced between a closed state in which the door part covers the switching section by closing the opening section and an opened state in which the door part exposes the switching section as viewed from the opening section by opening the opening section, wherein the switching section is displaced to a switching position where the switching section switches the transport direction of the medium when the door part is in the closed state, and is displaced to an opening position where the switching section opens the transport path when the door part is in the opened state and a through hole is formed in the switching section.

### BRIEF DESCRIPTION OF THE DRAWINGS

FIG. 1 is a front view illustrating an internal configuration of a printer according to a first embodiment of the present disclosure.

FIG. 2 is a front view illustrating a periphery of a switching section of the printer of FIG. 1, and is a view illustrating a state in which the switching section is positioned in a first state of a switching position.

FIG. 3 is a front view illustrating a periphery of the switching section of the printer of FIG. 1, and is a view illustrating a state in which the switching section is positioned in a second state of the switching position.

FIG. 4 is a front view illustrating a belt unit of the printer of FIG. 1.

FIG. 5 is a perspective view illustrating an accommodation section provided in the belt unit of the printer of FIG. 1.

FIG. 6 is a front view illustrating a periphery of the switching section of the printer of FIG. 1, and is a view illustrating a state in which the door part is opened and the switching section is positioned in a third state that is an opening position.

FIG. 7 is a diagram illustrating the switching section of the printer of FIG. 1.

FIG. 8 is a diagram for explaining a movement direction of foreign matters depositing to the switching section of the printer of FIG. 1.

FIG. 9 is a diagram for explaining a movement direction of foreign matters depositing to the switching section of the printer of FIG. 1.

FIG. 10 is a schematic cross-sectional view illustrating a state in which sheets of a medium are transported on the switching section of the printer of FIG. 1.

FIG. 11 is a diagram illustrating a switching section of a printer according to a second embodiment of the present disclosure.

FIG. 12 is a diagram for explaining a movement direction of foreign matters depositing to the switching section of the printer of FIG. 11, and is a diagram illustrating a state in which the switching section is positioned at the opening position.

FIG. 13 is a diagram for explaining a movement direction of foreign matters depositing to the switching section of the printer of FIG. 11, and is a diagram illustrating a state in which the switching section is positioned at the switching position.

FIG. 14 is a diagram illustrating a switching section of a printer according to a third embodiment of the present disclosure.

FIG. 15 is a diagram for explaining a movement direction of foreign matters depositing to the switching section of the printer of FIG. 14.

FIG. 16 is a diagram for explaining a movement direction of foreign matters depositing to a switching section of a printer of a reference example, and is a diagram illustrating a state when the switching section is displaced from the opening position to the switching position.

### DESCRIPTION OF EMBODIMENTS

Hereinafter, the present disclosure will be schematically described.

A medium transport device according to a first aspect includes a switching section that switches a transport direction of a medium in a transport path and a door part that is configured to open and close with respect to an opening section, and that is configured to be displaced between a closed state in which the door part covers the switching section by closing the opening section and an opened state in which the door part exposes the switching section as viewed from the opening section by opening the opening section, wherein the switching section is displaced to a switching position where the switching section switches the transport direction of the medium when the door part is in the closed state, and is displaced to an opening position where the switching section opens the transport path when the door part is in the opened state and a through hole is formed in the switching section.

According to the present aspect, the through hole is formed in the switching section. With such a configuration, even when foreign matter falls on the switching section at the opening position, the foreign matter can pass through the through hole, and thus it is possible to suppress the foreign matter from being accumulated on the switching section. Further, even in a case where the foreign matter deposits to a position other than the through hole of the switching section, when the switching section is displaced from the opening position to the switching position in accordance with closing of the door part, the foreign matter can be passed through the through hole by air passing through the through hole, and thus, the foreign matter can be suppressed from being moved to a position other than a desired position. Therefore, it is possible to suppress scattering of the foreign matter depositing to the switching section in the device.

A medium transport device according to a second aspect is an aspect according to the first aspect, and the switching section includes a rib across which the medium slides and the through hole is formed outside the rib with respect to a center in a width direction intersecting the transport direction of the medium.

According to the present aspect, the switching section includes the rib across which the medium slides, and the through hole is formed outside the rib with respect to the center in the width direction. With such a configuration, since an end section of the medium being transported can be lifted by the rib, it is possible to suppress the end section of the medium from being caught by the through hole. Therefore, it is possible to suppress a decrease in the transport accuracy of the medium.

A medium transport device according to a third aspect is an aspect according to the first or second aspect, and the through hole has a shape in which a longitudinal direction is along the transport direction of the medium.

According to the present aspect, the through hole has a shape in which the longitudinal direction is along the transport direction of the medium. With such a configuration, it is possible to suppress the end section of the medium from being caught by the through hole. Therefore, it is possible to suppress a decrease in the transport accuracy of the medium.

A medium transport device according to a fourth aspect is an aspect according to any one of the first to third aspects, and the medium transport device further includes a first transport roller that transports the medium, wherein the switching section includes a first facing region that faces the first transport roller above the first transport roller at the opening position, and a first non-facing region that does not face the first transport roller above the first transport roller at the opening position and the through hole is formed in the first non-facing region.

According to the present aspect, the through hole of the switching section is formed in the first non-facing region that does not face the first transport roller above the first transport roller at the opening position. With such a configuration, it is possible to effectively suppress the foreign matter from depositing to the first transport roller.

A medium transport device according to a fifth aspect is an aspect according to the fourth aspect, and the switching section includes a holding section that holds foreign matter in the first facing region and the holding section is positioned between the first transport roller and the first facing region when the switching section is positioned at the switching position.

According to the present aspect, the switching section includes the holding section that holds the foreign matter in the first facing region, and the holding section is positioned between the first transport roller and the first facing region when the switching section is positioned at the switching position. With such a configuration, in a case where the through hole is not provided in the first facing region, the foreign matter can be held by the holding section.

A medium transport device according to a sixth aspect is an aspect according to the fifth aspect, and the holding section is provided across the entire switching section in a width direction intersecting the transport direction of the medium.

According to the present aspect, the holding section is provided across the entire switching section in the width direction. With such a configuration, since the foreign matter can be held over the entire width direction of the switching section, it is possible to effectively suppress the foreign matter from depositing to the first transport roller.

A medium transport device according to a seventh aspect is an aspect according to the fifth aspect, and the holding section is provided over an entire width of the first transport roller in a width direction intersecting the transport direction of the medium.

According to the present aspect, the holding section is provided over the entire width of the first transport roller in the width direction. With such a configuration, it is possible to suppress falling of the foreign matter over the entire width direction of the first transport roller, and thus it is possible to effectively suppress the foreign matter from depositing to the first transport roller.

A medium transport device according to an eighth aspect is an aspect according to any one of the fifth to seventh aspects, and the medium transport device further includes a protection section that protects the first transport roller, wherein the holding section and the protection section are positioned between the first transport roller and the first facing region when the switching section is positioned at the switching position and the protection section overlaps with the holding section in a direction of viewing the first transport roller from the first facing region.

According to the present aspect, the medium transport device includes the protection section that protects the first transport roller, the holding section and the protection section are positioned between the first transport roller and the first facing region when the switching section is positioned at the switching position, and the protection section overlaps with the holding section in a direction of viewing the first transport roller from the first facing region. With such a configuration, the protection section and the holding section can effectively suppress the foreign matter from depositing to the first transport roller.

A medium transport device according to a ninth aspect is an aspect according to the fourth aspect, and when the switching section is at the opening position, a surface of the first facing region that faces upward is defined as an upper surface, and the upper surface is a flat surface.

According to the present aspect, the upper surface of the first facing region of the switching section is the flat surface. With such a configuration, in a case where the through hole cannot be provided in the first facing region, or the like, it is possible to suppress accumulation of the foreign matter in the first facing region.

A medium transport device according to a tenth aspect is an aspect according to any one of the first to ninth aspects, and the medium transport device further includes a separation roller pair that separates sheets of the medium, wherein the switching section includes a second facing region that faces the separation roller pair at the switching position and a second non-facing region that does not face the separation roller pair at the switching position and the through hole is formed in the second facing region.

According to the present aspect, the switching section includes the second facing region that faces the separation roller pair at the switching position and the second non-facing region that does not face the separation roller pair at the switching position, and the through hole is formed in the second facing region. A roller of the separation roller pair is more likely to cause a transport failure such as multi-feeding due to a decrease in a frictional force caused by deposit of the foreign matter than a roller of the other transport roller pair or the like, but with such a configuration, by providing the through hole in the second facing region that faces the separation roller pair at the switching position, it is possible to release the foreign matter positioned in the second facing region through the through hole. That is, it is possible to suppress the foreign matter from accumulating in the second facing region, and it is possible to suppress the foreign matter from depositing to the separation roller pair when the switching section returns from the opening position to the switching position. Therefore, it is possible to suppress a decrease in the transport accuracy.

A recording device according to an eleventh aspect includes the medium transport device according to the tenth aspect and a recording section that performs recording on the medium transported by the medium transport device.

According to the present aspect, it is possible to perform recording while suppressing scattering of the foreign matter deposited on the switching section in the device.

A recording device according to a twelfth aspect is an aspect according to the eleventh aspect, and the recording device further includes a support section that faces the recording section and that supports the medium on which recording is performed by the recording section, wherein the support section is configured to be displaced between a facing position where the support section faces the recording section and a separation position where the support section is separated from the recording section and the support section is positioned above the switching section.

According to the present aspect, the recording device includes the support section that faces the recording section and that supports the medium on which recording is performed by the recording section, and the support section is configured to be displaced between the facing position where the support section faces the recording section and the separation position where the support section is separated from the recording section, and the support section is positioned above the switching section. In a configuration in which the support section is positioned above the switching section and is displaceable, there is a possibility that the foreign matter may fall onto the switching section from above due to the displacement of the support section, but even in such a configuration, it is possible to suppress the foreign matter from being moved to a position other than a desired position as described above, and thus, it is possible to suppress the influence of the foreign matter.

A recording device according to a thirteenth aspect is an aspect according to the twelfth aspect, and the support section includes a transport belt that transports the medium, a cleaning section that cleans the transport belt, and an accommodation section that accommodates foreign matter removed by the cleaning section.

According to the present aspect, the support section includes the transport belt that transports the medium, the cleaning section that cleans the transport belt, and the accommodation section that accommodates the foreign matter removed by the cleaning section. In a case of a configuration in which the support section includes the accommodation section, the foreign matter may fall from the accommodation section due to the displacement of the support section, but even in such a configuration, it is possible to suppress the foreign matter from being moved to a position other than a desired position as described above, and thus, it is possible to suppress the influence of the foreign matter.

A recording device according to a fourteenth aspect includes the medium transport device according to any one of the first to ninth aspects and a recording section that performs recording on the medium transported by the medium transport device.

According to the present aspect, it is possible to perform recording while suppressing scattering of the foreign matter deposited on the switching section in the device.

A recording device according to a fifteenth aspect includes the medium transport device according to any one of the fourth to ninth aspects; a recording section that performs recording on the medium transported by the medium transport device; and a second transport roller that transports the medium on which recording is not performed by the recording section, wherein the first transport roller transports the medium on which recording was performed by the recording section, the switching section includes a third facing region that faces the second transport roller at the opening position and a third non-facing region that does not face the second transport roller at the opening position, and the through hole is formed in the third facing region.

According to the present aspect, it is possible to perform recording while suppressing scattering of the foreign matter deposited on the switching section in the device.

### First Embodiment

The present disclosure will be described in detail below. First, an inkjet printer 1 of a first embodiment that is a medium transport device and a recording device of the present disclosure will be described. Hereinafter, a printer 1 of the present embodiment that is the inkjet printer 1 is abbreviated as a printer 1A. An X-Y-Z coordinate system illustrated in each drawing is an orthogonal coordinate system, and a Y-axis direction is a direction intersecting a transport direction of a medium P, that is, a medium width direction, and is also an device depth direction. In the Y-axis direction, a +Y direction is a direction from a device front surface toward a device rear surface, and a −Y direction is a direction from the device rear surface toward the device front surface.

An X-axis direction is a device width direction and, as viewed from an operator of the printer 1A, a +X direction is to a left side and a −X direction is to a right side. A Z-axis direction is a vertical direction, that is, a device height direction, a +Z direction is an upward direction, and a −Z direction is a downward direction. Hereinafter, a direction in which the medium P is transported may be referred to as “downstream”, and an opposite direction of it may be referred to as “upstream”. In each drawing, a transport path of a medium is indicated by a broken line. In the printer 1A, the medium P is transported through the transport path indicated by a broken line.

The printer 1A includes a housing section 16 of a device main body 2, and a door part 17 that is pivotable about the Z-axis direction with respect to the housing section 16. The opening section 18 provided in the housing section 16 can be opened by opening the door part 17, and the opening section 18 can be closed by closing the door part 17. The printer 1A includes a first medium cassette 3 that accommodates the medium P at the bottom of the device main body 2, and is further configured so that an additional unit 6 can be connected to the bottom of the device main body 2. When the additional unit 6 is connected, a second medium cassette 4 and a third medium cassette 5 are positioned below the first medium cassette 3. The medium P fed from each medium cassette is transported along the transport path indicated by a broken line inside the printer 1A.

Each of the medium cassettes is provided with a pickup roller that feeds the accommodated medium P in the-X direction. The pickup rollers 21, 22, and 23 are pickup rollers provided for the first medium cassette 3, the second medium cassette 4, and the third medium cassette 5, respectively. Each medium cassette is provided with a feed roller pair that feeds the medium P, which was fed in the −X direction, in an obliquely upward direction. The feed roller pairs 25, 26, and 27 are feed roller pairs provided for the first medium cassette 3, the second medium cassette 4, and the third medium cassette 5, respectively. In the following description, unless otherwise specified, a “roller pair” is configured by a drive roller driven by a motor (not illustrated) and a driven roller that is in contact with the drive roller and that is driven to rotate.

The medium P fed from the third medium cassette 5 is fed to an inversion roller 39 by transport roller pairs 29 and 28. The medium P fed from the second medium cassette 4 is fed to the inversion roller 39 by the transport roller pair 28. The medium P is nipped by the inversion roller 39 and a driven roller 40 and is fed to a transport roller pair 31. The medium P fed from the first medium cassette 3 is fed to the transport roller pair 31 without passing through the inversion roller 39. A feed roller 19 and a separation roller 20 provided in the vicinity of the inversion roller 39 are a roller pair that feeds the medium P from a feed tray 12.

The transport path of the medium P from the feed roller pair 25 to the transport roller pair 31 is curved so as to be convex downward. The transport path of the medium P from a nip position between the inversion roller 39 and the driven roller 40 to the transport roller pair 31 is also curved so as to be convex downward. Hereinafter, the transport path of the medium P from the feed roller pair 25 to the transport roller pair 31 and the transport path of the medium P from the nip position between the inversion roller 39 and the driven roller 40 to the transport roller pair 31 are referred to as a curved transport path R1.

The curved transport path R1 is provided with a detection unit 70 that detects the medium P and a switching section 100 that switches the transport paths of the medium P. The switching section 100 of the present embodiment is referred to as a switching section 100A. The detection unit 70 detects the presence or absence of the medium P transported on the curved transport path R1 and detects a width of the medium P by detecting an end section of the medium P in the medium width direction. The details of the switching section 100A, which is a main part of the printer 1A of the present embodiment, will be described later.

The medium P receiving a feeding force from the transport roller pair 31 is fed to a position between a line head 51, which is an example of a recording section, and a transport belt 13, that is, a recording position facing the line head 51. Hereinafter, the transport path from the transport roller pair 31 to a transport roller pair 32 is referred to as a recording transport path T1.

The line head 51 constitutes a head unit 50. The line head 51 performs recording by ejecting ink, which is an example of liquid, onto a surface of the medium P. The line head 51 is an ink ejection head configured such that nozzles for ejecting ink cover an entire region in the medium width direction, and is configured as an ink ejection head that is capable of recording on the entire region in the medium width direction without being moved in the medium width direction. However, the ink ejection head is not limited to this, and may be of a type that is mounted on a carriage and that ejects ink while moving in the medium width direction. As the recording section, a recording section including a configuration other than the ink ejection head, such as a thermal transfer type recording section, may be used.

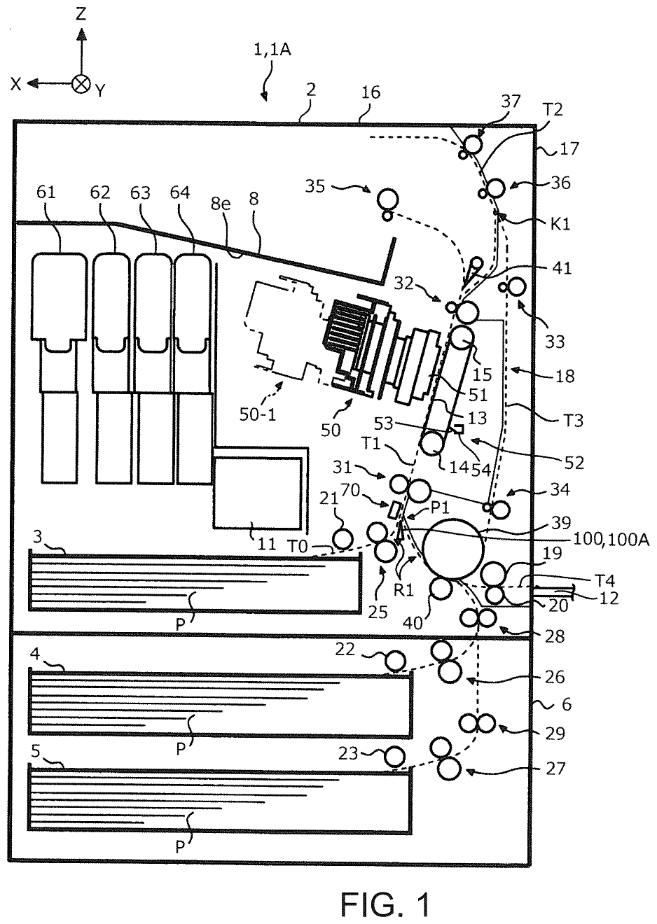

The head unit 50 is provided so as to be able to advance and retreat with respect to the recording transport path T1, and is provided so as to be able to be displaced between a recording position indicated by a solid line in FIG. 1 and a retreat position where the head unit 50 is retreated most from the transport belt 13 as indicated by a two dot chain line and reference symbol 50-1 in FIG. 1. When the head unit 50 is in the retreat position, the line head 51 is maintained by a maintenance unit (not illustrated). The head unit 50 is positioned on an upstream side in a medium discharge direction on a lower side of a discharge tray 8, and is displaced along a lower surface 8e of the discharge tray 8.

The printer 1A includes ink containers 61, 62, 63, and 64 as liquid containers. Ink being ejected from the line head 51 is supplied to the line head 51 from each ink container via tubes (not illustrated). Each ink container is detachably provided. The printer 1A includes a waste liquid container 11 that stores ink as waste liquid ejected from the line head 51 toward a flushing cap (not illustrated) for maintenance.

The transport belt 13 is an endless belt that is wound around a pulley 14 and a pulley 15, and rotates by at least one of the pulley 14 and the pulley 15 being driven by a motor (not illustrated). The medium P is transported to a position facing the line head 51 while being attracted to a belt surface of the transport belt 13. A known attraction method such as an air suction method or an electrostatic adsorption method can be used to attract the medium P onto the transport belt 13. Although details will be described later, a belt unit 52 as a support section that supports the medium P on which recording is performed by the line head 51 is configured by a blade 53 that is a cleaning section that cleans the transport belt 13, and an accommodation section 54 that accommodates foreign matter T such as paper dust removed by the blade 53, in addition to the transport belt 13, the pulley 14, and the pulley 15.

The recording transport path T1 passing through a position facing the line head 51 is configured to form an angle with respect to a horizontal direction and the vertical direction and transport the medium P upward. The upward transport direction is a direction including a −X direction component and a +Z direction component in FIG. 1. The medium P on which recording is performed on a first surface by the line head 51 is further fed in the upward direction by the transport roller pair 32 positioned downstream of the transport belt 13. A flap 41 is provided downstream of the transport roller pair 32, and the transport direction of the medium P is switched by the flap 41. In a case where the medium P is discharged as it is, the transport paths of the medium P is switched by the flap 41 so as to be directed to a transport roller pair 35 on an upper side, and the medium P is discharged toward the discharge tray 8 by the transport roller pair 35.

When recording is performed on a second surface of the medium P opposite to the first surface in addition to the first surface, the transport direction of the medium P is directed to a branch position K1 by the flap 41. Then, the medium P pass through the branch position K1 and enter a switchback path T2. In the present embodiment, the switchback path T2 is a transport path on an upper side from the branch position K1. Transport roller pairs 36 and 37 are provided in the switchback path T2. The medium P that has entered the switchback path T2 is transported substantially upward by the transport roller pairs 36 and 37, and when a trailing edge of the medium P has passed through the branch position K1, a rotational direction of the transport roller pairs 36 and 37 is switched, and the medium P is thereby transported substantially downward.

An inversion path T3 is connected to the switchback path T2. In the present embodiment, the inversion path T3 is a transport path from the branch position K1 through transport roller pairs 33 and 34 and the inversion roller 39 to a merging point P1. The medium P transported downward from the branch position K1 receives a feeding force from the transport roller pairs 33 and 34, reaches the inversion roller 39, is curved and inverted by the inversion roller 39, and is transported toward the transport roller pair 31.

In the medium P transported by the transport roller pair 31 or the like and fed to a position facing the line head 51 again, the second surface opposite to the first surface on which recording has been performed faces the line head 51. By this, it is possible to perform recording on the second surface of the medium P by the line head 51. Here, a transport path from the first medium cassette 3 to the switching section 100A is referred to as a feed path T0. Therefore, it can be expressed that the switching section 100A is provided at the merging point P1 of the feed path T0 and the inversion path T3, and a transport path to the transport roller pair 32 on a downstream side of the merging point P1 of the feed path T0 and the inversion path T3 constitutes the recording transport path T1. A transport path of the medium P fed from the feed tray 12 by the feed roller 19 and the separation roller 20 is referred to as a feed path T4.

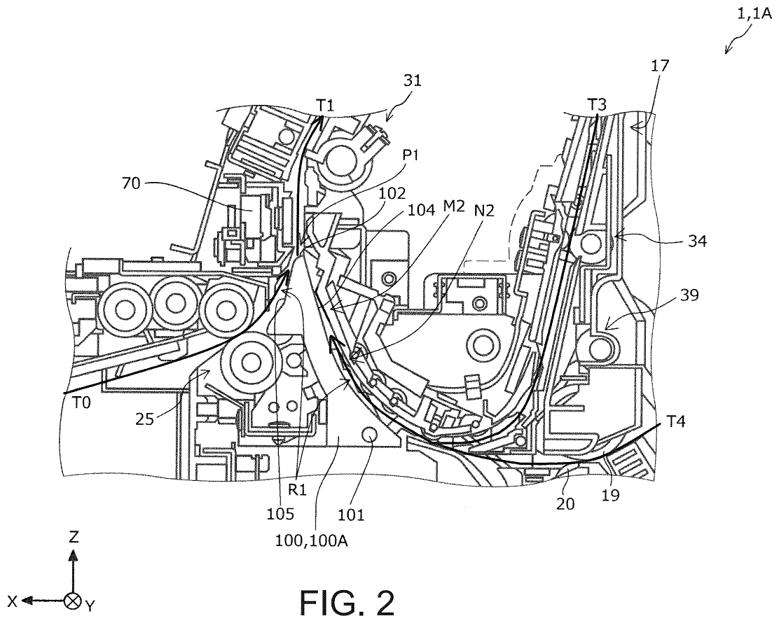

As described above, the printer 1A includes the door part 17 that can be opened and closed with respect to the opening section 18 and can be displaced between a closed state in which the door part 17 covers the switching section 100A by closing the opening section 18 and an opened state in which the door part 17 exposes the switching section 100A as viewed from the opening section 18 by opening the opening section 18. The switching section 100A is configured to be capable of switching the transport direction of the medium P in the transport path. The switching section 100A, which is a main part of the printer 1A, will be described in detail with reference to FIGS. 2 to 9.

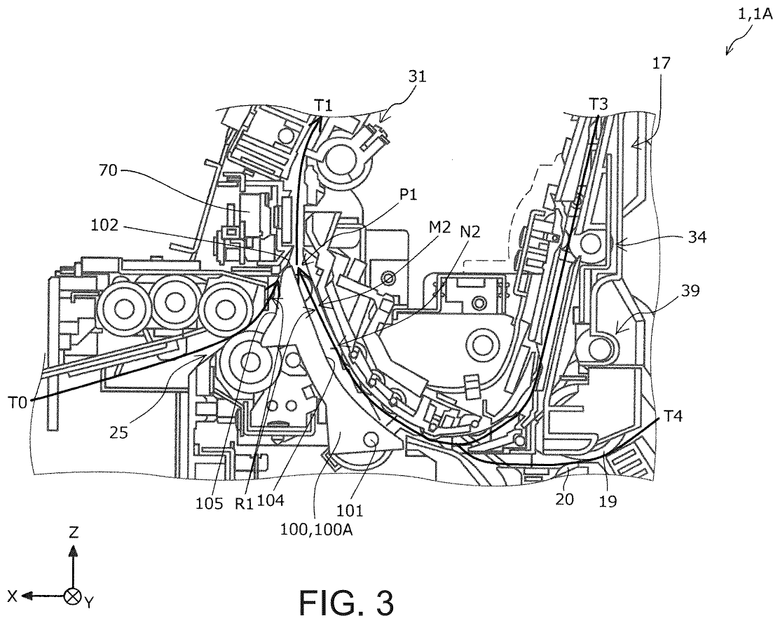

The switching section 100A serves to switch between the feed path T0 and the inversion path T3. In detail, when the medium P is fed from the first medium cassette 3, as illustrated in FIG. 2, the feed path T0 is opened and the inversion path T3 is closed. On the other hand, when recording is performed on the first surface of the medium P and then recording is performed on the second surface of the medium P, or when the additional unit 6 is connected to the device main body 2 and the medium P is fed from the second medium cassette 4 or the third medium cassette 5, the inversion path T3 is opened and the feed path T0 is closed as illustrated in FIG. 3. Similarly, when the medium P is fed from the feed tray 12, the inversion path T3 is opened and the feed path T0 is closed as illustrated in FIG. 3.

As illustrated in FIGS. 2 and 3, a switching section's pivot shaft 101, which is a pivot shaft extending in the Y-axis direction, is formed in the switching section 100A. The switching section 100A can pivot with reference to the switching section's pivot shaft 101. In FIGS. 2 and 3, a distal end 102 of the switching section 100A on a side opposite to the switching section's pivot shaft 101 is positioned on a +X direction side of the switching section's pivot shaft 101. Therefore, the switching section 100A has a second state illustrated in FIG. 3 as a basic posture due to its own weight. However, when the medium P is fed from the first medium cassette 3, a leading edge of the medium P being fed in a feed direction presses a contact region 105 of the switching section 100A toward a −X direction side while being in contact with the switching section 100A, and thus the switching section 100A is in a first state illustrated in FIG. 2.

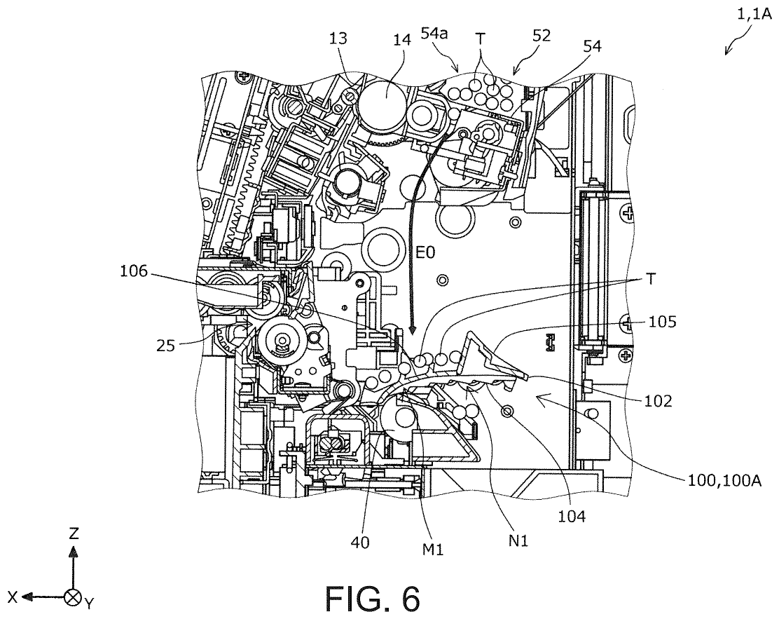

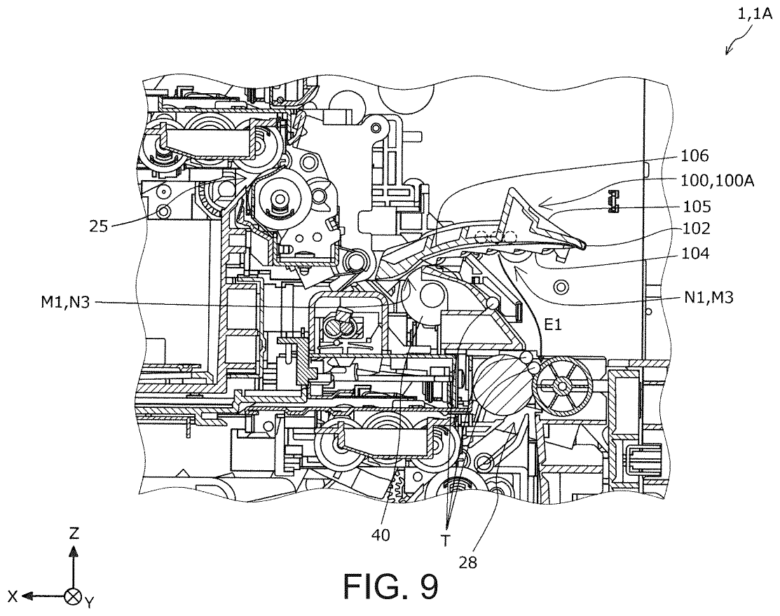

Here, the printer 1A can be in the closed state in which the door part 17 is closed with respect to the opening section 18 of the housing section 16 corresponding to the case illustrated in FIGS. 2 and 3, and can be in an opened state in which the door part 17 is opened with respect to the opening section 18. When the printer 1A is in the opened state in which the door part 17 is opened with respect to the opening section 18, the switching section 100A is in a third state as illustrated in FIGS. 6 and 9. When the switching section 100A is switched from the second state to the third state by opening the door part 17, the switching section T0 pivots to open the feed path T0 as viewed from the opening section 18. That is, as illustrated in FIGS. 2 and 3, the switching section 100A can be displaced to a switching position at which the transport direction of the medium P is switched when the door part 17 is positioned in the closed state. Further, as illustrated in FIGS. 6 and 9, when the door part 17 is positioned in the opened state, the door part 17 can be displaced to an opening position at which the transport path is opened.

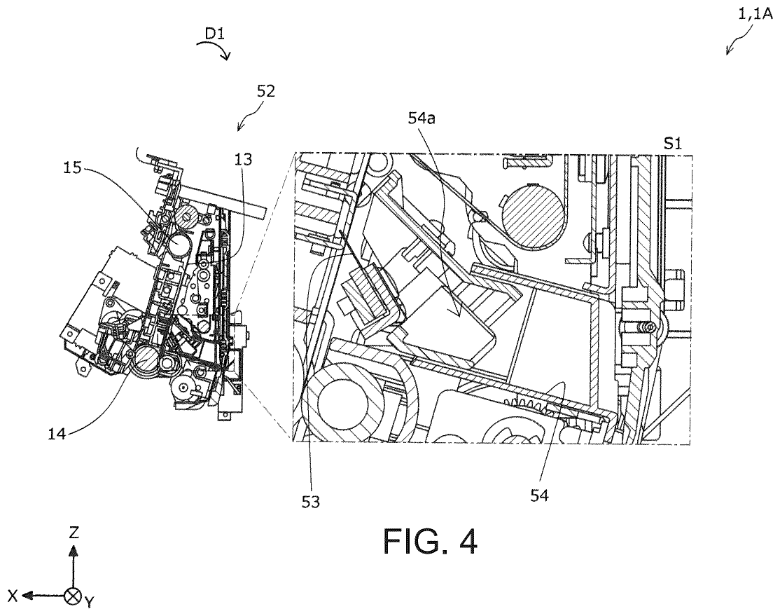

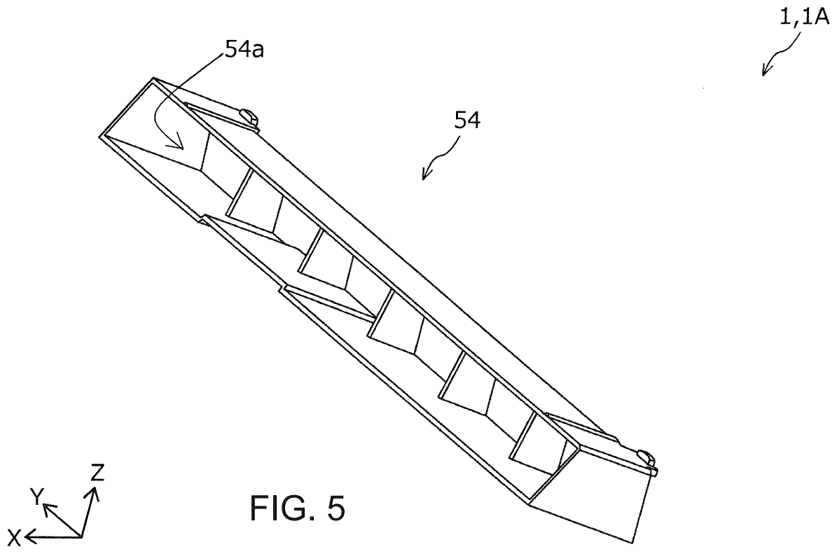

Here, when the door part 17 is in the opened state, the belt unit 52 illustrated in FIG. 4 is also exposed when viewed from the opening section 18. As described later, when the door part 17 is in the opened state, the belt unit 52 can also be opened through the opening section 18. As illustrated in an enlarged view of a region S1 in FIG. 4 and FIG. 5, the accommodation section 54 constituting the belt unit 52 is provided with an opening 54a on a side facing the transport belt 13. The belt unit 52 is configured to scrape off the foreign matter T such as paper dust depositing to the transport belt 13 by the blade 53 and accommodate the foreign matter T in the accommodation section 54 through the opening 54a.

However, since the opening 54a is provided in the accommodation section 54, when the belt unit 52 is exposed when viewed from the opening section 18, the foreign matter T accommodated in the accommodation section 54 may spill from the opening 54a due to a user touching constituent members of the belt unit 52 such as the transport belt 13. Then, as illustrated in FIG. 6, the foreign matter T spilled from the accommodation section 54 may fall in a direction of arrow E0 and be accumulated on the switching section 100A in the third state.

The printer 1A is a medium transport device that can collect the foreign matter T such as paper dust depositing to the medium P with the belt unit 52 inside the device. As described above, the accommodation section 54 that collects the foreign matter T when the transport belt 13 is cleaned by the blade 53 is provided. The belt unit 52 of the present embodiment is configured to be pivotable about the pulley 14 as a pivot shaft in a direction D1 in FIG. 4. With such a configuration, when a jam occurs, a jammed medium can be easily removed. However, since the printer 1A includes such a configuration, the foreign matter T accommodated in the accommodation section 54 may spill from the opening 54a when the belt unit 52 is pivoted in the direction D1 and then the belt unit 52 is returned.

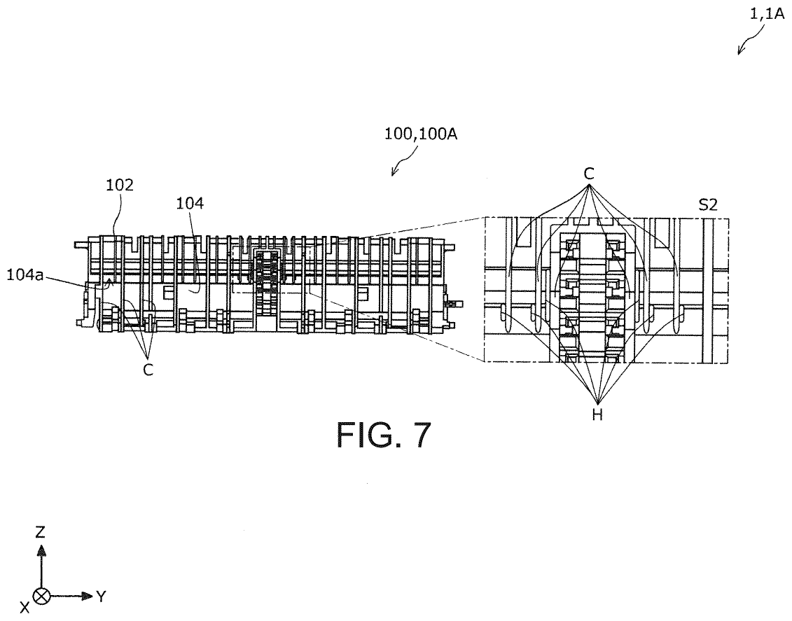

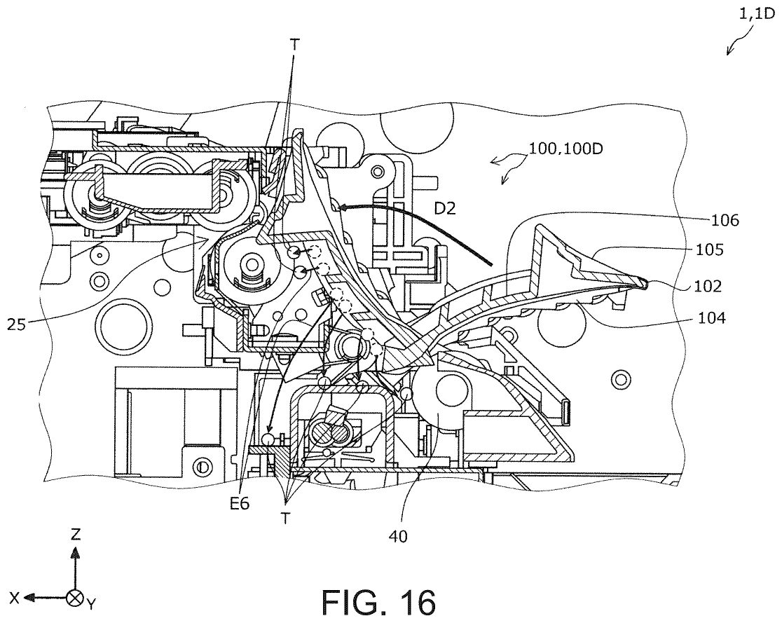

As illustrated in FIG. 6, when the foreign matter T is accumulated on the switching section 100A in the third state, in a case where the door part 17 is set to the closed state in such a state and the switching section 100A is returned to the second state, there is a possibility that the foreign matter T may deposit to the feed roller pair 25. For example, FIG. 16 illustrates a state in which the foreign matters T accumulated on a switching section 100D move in a direction of arrow E6 and deposit to the feed roller pair 25 in a printer 1D of a reference example. Therefore, the printer 1A of the present embodiment is configured such that the foreign matter T is not easily accumulated on the switching section 100A in the third state. Specifically, as illustrated in FIG. 7 and the like, a plurality of through holes H are formed in the switching section 100A. The through hole H is not formed in the switching section 100D of the printer 1D of the reference example.

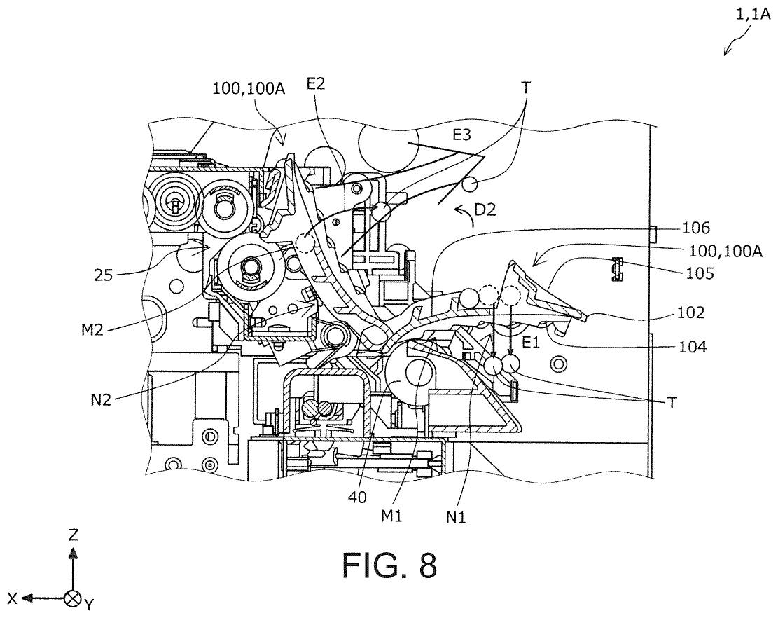

With such a configuration, the printer 1A of the present embodiment can pass the foreign matters T through the through holes H as indicated by arrow E1 in FIG. 8 even when the foreign matters T falls on the switching section 100A at the opening position. Therefore, it is possible to suppress accumulation of the foreign matter T on the switching section 100A. Even when the foreign matter T deposits to a position other than the through hole H of the switching section 100A, as indicated by arrow E2 in FIG. 8, when the switching section 100A moves in a pivot direction D2 as the door part 17 closes and displaces from the opening position to the switching position, an air flow E3 passing through the through hole H allows the foreign matter T to pass through the through hole H. Therefore, it is possible to suppress the foreign matter T from being moved to a position other than a desired position where the foreign matter T does not substantially cause a problem even if the foreign matter T deposits.

Therefore, the printer 1A can suppress scattering of the foreign matter T depositing to the switching section 100A in the device. The shape and size of the through hole H are not particularly limited. However, it is desirable that the shape and size of the switching section 100A do not impair the strength of the switching section 100A. Although FIGS. 8 and 16 illustrate both the switching section 100 at the opening position and the switching section 100 at the switching position, the switching section 100 is merely illustrated as moving to the pivot direction D2 and being displaced from the opening position to the switching position, and the printer 1 includes only one switching section 100.

From the perspective of a recording device, the printer 1A includes a medium transport device in which the through hole H is formed in the switching section 100A, and the line head 51 that performs recording on the medium P transported by the medium transport device. Therefore, the printer 1A can perform recording while suppressing scattering of the foreign matter T depositing to the switching section 100A in the device.

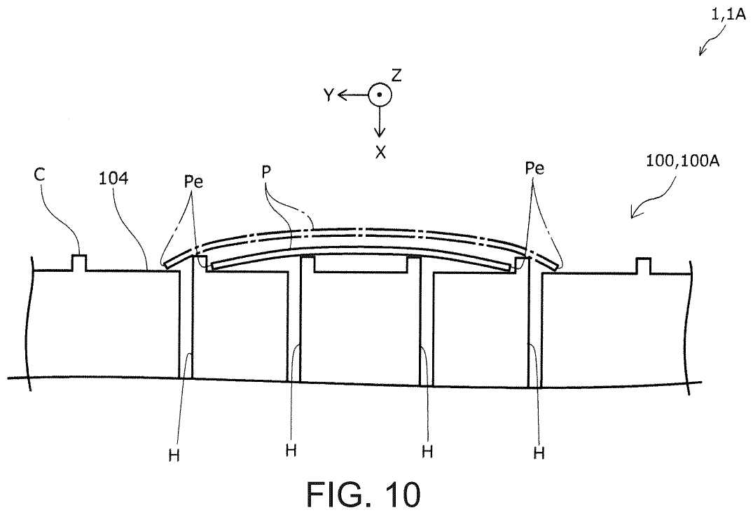

As illustrated in FIGS. 2 and 3, the printer 1A includes a contact region 104 and the contact region 105, which are regions that come into contact with the medium P being transported, in the switching section 100A. The contact region 104 is a region that comes into contact with the medium P transported from the inversion path T3 and the feed path T4 to the recording transport path T1, and the contact region 105 is a region that comes into contact with the medium P transported from the feed path T0 to the recording transport path T1. As illustrated in FIGS. 7 and 10, the contact region 104 is provided with ribs C extending in a direction along the transport direction.

That is, the switching section 100A includes the ribs C across which the medium P being transported slide. As illustrated in an enlarged view of a region S2 in FIG. 7 and in FIG. 10, the through holes H are formed on an outer side of the ribs C with respect to the center in the width direction (Y-axis direction) intersecting the transport direction of the medium P. With such a configuration of the printer 1A, since an end section Pe of the medium P being transported can be lifted by the rib C, it is possible to suppress the end section Pe of the medium P from being caught by the through hole H. In particular, the end section Pe of the medium P may be positioned in the vicinity of the through hole H depending on the size of a medium in the width direction. In such a case, the rib C can lift the end section Pe of the medium P being transported, thereby more effectively suppressing the end section Pe of the medium P from being caught by the through hole H. Therefore, the printer 1A can suppress a decrease in the transport accuracy of a medium.

In the printer 1A, the switching section 100A is formed from resin by injection molding, but the thickness is made as constant as possible in order to suppress deformation accompanying injection molding. Therefore, as illustrated in FIG. 7, the switching section 100A is provided with a recess section 104a that is recessed when viewed from a contact region 104 side, and the recess section 104a serves as downgauging. In a case where the recess section 104a is provided in this manner, the foreign matter T tends to accumulate in the recess section 104a, so it is more effective to take measures as in the present embodiment.

In the printer 1A, as illustrated in FIG. 7, the through hole H has a shape in which a longitudinal direction is along the transport direction of the medium P. By configuring the printer 1A in this manner, it is possible to effectively suppress the end section Pe of the medium P from being caught by the through hole H. Therefore, the printer 1A can effectively suppress a decrease in the transport accuracy of the medium P.

Here, in the printer 1D of the reference example, in a case where the foreign matter T is accumulated on the switching section 100D, since a through hole is not provided, it can be considered that there is a possibility that the foreign matter T may deposit to the feed roller pair 25 and the driven roller 40 from a positional relationship with respect to the switching section 100D. In the printer 1A, in a case where the through hole H is provided in the entire region of the switching section 100A, it can be considered that there is a possibility that the foreign matter T may deposit to the transport roller pair 28 and the driven roller 40 from a positional relationship with respect to the switching section 100A. As illustrated in FIGS. 2, 3, and 8, a partial region of the feed roller pair 25 faces the switching section 100A in the X-axis direction when the switching section 100A is at the switching position corresponding to the first state and the second state. It is conceivable that the foreign matter T may deposit to the feed roller pair 25 when the switching section 100A is displaced from the opening position corresponding to the third state to the switching position.

As illustrated in FIGS. 6 and 8, a partial region of the driven roller 40 faces the switching section 100A in the Z-axis direction when the switching section 100A is at the opening position. The foreign matter T may deposit to the driven roller 40 when the foreign matter T falls downward when the switching section 100A is at the opening position. As illustrated in FIG. 9, a partial region of the transport roller pair 28 faces the switching section 100A in the Z-axis direction when the switching section 100A is at the opening position. The foreign matter T may deposit to the transport roller pair 28 when the foreign matter T falls downward when the switching section 100A is at the opening position.

Here, the feed roller pair 25 is a separation roller pair capable of separating sheets of the multi-fed medium P. Since a separation roller pair requires a strong frictional force when separating sheets of the multi-fed medium P, a decrease in the frictional force due to deposit of the foreign matter T is not preferable. For example, a separation roller pair is configured to separate one sheet of the medium P to be fed by a feed roller that applies a transporting force in a transport direction F to one sheet of the medium P to be fed and a separation roller that applies a force that inhibits movement in the transport direction F to sheets of the medium P other than one sheet of the medium P to be fed. At this time, the foreign matter T deposits to the separation roller, and thus, a force that inhibits movement in the transport direction is weakened, and there is a possibility that this may lead to a transport failure such as multi-feeding. Therefore, it is desirable to avoid deposit of the foreign matter T to the separation roller pair as much as possible.

The driven roller 40 nips and transports the medium P together with the inversion roller 39, and the driven roller 40 and the inversion roller 39 are provided on the inversion path T3 when recording is performed on the first surface and then on the second surface. When the medium P on which recording was performed on the first surface is transported, it is desirable that a nip force by the driven roller 40 and the inversion roller 39 is not strong in order to suppress disturbance of a recorded image formed on the first surface. Therefore, it is necessary to suppress a decrease in a transporting force of the driven roller 40, and it is desirable to avoid deposit of the foreign matter T to the driven roller 40 as much as possible.

On the other hand, the transport roller pair 28 may be able to allow deposit of the foreign matter T as compared with the feed roller pair 25 and the driven roller 40. Therefore, the transport roller pair 28 does not need to take as strict measures against deposit of the foreign matter T as the feed roller pair 25 and the driven roller 40.

The above will be described in order corresponding to the printer 1A using another expression. First, the driven roller 40 as a first transport roller will be described. As described above, the printer 1A includes the driven roller 40 as the first transport roller that transports the medium P. Here, as illustrated in FIGS. 6, 8, and 9, the switching section 100A includes a first facing region M1 that faces the driven roller 40 above the driven roller 40 at the opening position, and a first non-facing region N1 that does not face the driven roller 40 above the driven roller 40 at the opening position. The through hole H is formed in the first non-facing region N1.

By configuring the printer 1A in this manner, even if the foreign matter T is accumulated on the first facing region M1 of the switching section 100A at the opening position, it is possible to suppress the foreign matter T from falling onto the driven roller 40 through the through hole H, and it is possible to effectively suppress deposit of the foreign matter T to the driven roller 40. However, in a case where there is any constituent member between the first facing region M1 and the driven roller 40, even if a position of the first facing region M1 is above a position of the driven roller 40, it can be considered that they do not face each other. In a case where deposit of the foreign matter T to the driven roller 40 is not particularly problematic, such as a case where some measures against deterioration in performances due to deposit of the foreign matter T are taken for the driven roller 40, the through hole H may be provided in the first facing region M1.

Here, at least a part of an upper surface 106 of the switching section 100A, which faces upward at the opening position of the first facing region M1, may be a flat surface. With such a configuration, the foreign matter T is likely to move on the upper surface 106, and the foreign matter T moves from the first facing region M1, so that it is possible to suppress the foreign matter T from being accumulated on the first facing region M1 in a case where the through hole H cannot be provided in the first facing region M1, or the like. The upper surface 106 may or may not be a horizontal surface when the switching section 100A is at the opening position corresponding to the third state, but when the upper surface 106 is not a horizontal surface, the foreign matter T is easily moved in a desired direction.

Next, the feed roller pair 25 as a separation roller pair will be described. As described above, the printer 1A includes the feed roller pair 25 as the separation roller pair that separate sheets of the medium P. Here, as illustrated in FIGS. 2, 3, and 8, the switching section 100A includes a second facing region M2 that faces the feed roller pair 25 in the X-axis direction at the switching position, and a second non-facing region N2 that does not face the feed roller pair 25 at the switching position. The through hole H is formed in the second facing region M2.

The rollers of the separation roller pair are more likely to lead to a transport failure such as multi-feeding due to a decrease in a frictional force caused by deposit of the foreign matter T than the rollers of the other transport roller pairs, but the printer 1A includes such a configuration, and the through hole H is provided in the second facing region M2 facing the feed roller pair 25 that is the separation roller pair at the switching position, and thus, it is possible to release the foreign matter T positioned in the second facing region M2 through the through hole H. For example, as illustrated in FIG. 8, the air flow E3 passing through the through hole H allows the foreign matter T positioned in the second facing region M2 to pass through the through hole H as indicated by arrow E2, and allows the foreign matter T positioned in the second facing region M2 to pass through the through hole H. Therefore, the printer 1A can suppress accumulation of the foreign matter T in the second facing region M2, and can suppress deposit of the foreign matter T to the feed roller pair 25 when the switching section 100A returns from the opening position to the switching position. Therefore, the printer 1A can suppress a decrease in the transport accuracy.

Finally, the transport roller pair 28 as a second transport roller will be described. As illustrated in FIG. 9, the switching section 100A includes a third facing region M3 that faces the transport roller pair 28 at the opening position and a third non-facing region N3 that does not face the transport roller pair 28 at the opening position. The through hole H is formed in the third facing region M3. In the printer 1A, the third facing region M3 corresponds to the first non-facing region N1, and the third non-facing region N3 corresponds to the first facing region M1, but the disclosure is not limited to a configuration having such a correspondence relationship.

By configuring the printer 1A in this manner, it is possible to perform recording while suppressing scattering of the foreign matter T, which is deposited on the switching section 100A, in the device. From another viewpoint, in a transport roller pair that transports the medium P on which recording has not been performed yet, a harmful effect such as transfer is unlikely to occur even when a nip pressure is increased, but there is a possibility that transfer occurs when a nip pressure of a transport roller pair that transports the medium P on which recording was performed on at least one surface is increased. Therefore, in the transport roller pair 28 as the second transport roller, as measures against a decrease in a transporting force due to deposit of the foreign matter T such as paper dust, even if a nip pressure is increased in advance or a nip pressure is adjusted to be increased after the fact, a harmful effect is unlikely to occur, but in the driven roller 40 as the first transport roller, it is difficult to increase a nip pressure as in the second transport roller. That is, the transport roller pair 28 is less likely to cause a decrease in a transporting force even when the foreign matter T such as paper dust deposits to some extent. Therefore, as in the present embodiment, the through hole H is not provided at a position facing the first transport roller, and the through hole H is provided at a position facing the second transport roller, and thus it is possible to more effectively suppress the occurrence of a transport failure due to the foreign matter T.

As described above, the printer 1A includes the belt unit 52 as a support section that faces the line head 51 and supports the medium P on which recording is performed by the line head 51. As described above, the belt unit 52 is pivotable about the pulley 14 as a pivot shaft in the direction D1 in FIG. 4. In other words, the belt unit 52 is displaceable between a facing position where the belt unit 52 faces the line head 51 and a separation position where the belt unit 52 is separated from the line head 51. Here, as illustrated in FIG. 1, the belt unit 52 is positioned above the switching section 100A.

As described above, in a configuration in which the belt unit 52 is positioned above the switching section 100A and is displaceable as in the printer 1A, there is a possibility that the foreign matter T falls from above onto the switching section 100A due to the displacement of the belt unit 52. However, even in such a configuration in which the belt unit 52 is displaced, the foreign matter T can be suppressed from being moved to a position other than a desired position as described above by providing the through hole H at an appropriate position of the switching section 100A as in the printer 1A. Therefore, the printer 1A can suppress the influence of the foreign matter T.

As described above, the belt unit 52 of the printer 1A includes the transport belt 13 that transports the medium P, the blade 53 that cleans the transport belt 13, and the accommodation section 54 that accommodates the foreign matter T removed by the blade 53. In a configuration in which the belt unit 52 includes the accommodation section 54, the foreign matter T may fall from the accommodation section 54 due to the displacement of the belt unit 52, but even in such a configuration, the printer 1A can suppress the foreign matter T from being moved to a position other than a desired position as described above, and thus, the influence of the foreign matter T can be suppressed. In the accommodation section 54 of the present embodiment, a transport belt 13 side is the opening 54a, but the present disclosure is not limited to such a configuration.

### Second Embodiment

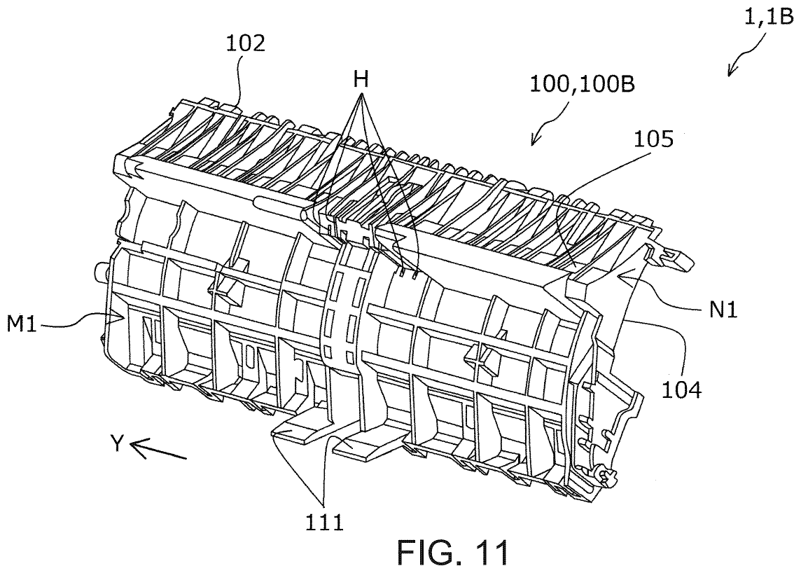

Next, a printer 1B as a medium transport device and a recording device of a second embodiment will be described with reference to FIGS. 11 to 13. In FIGS. 11 to 13, the same reference symbols are given to the same constituent members as those in the first embodiment, and the detailed description thereof will be omitted. Here, the printer 1B of the present embodiment includes the same configuration as the printer 1A of the first embodiment except for a configuration of a switching section 100 (switching section 100B) described below. Therefore, the printer 1B of the present embodiment has the same features as the printer 1A of the first embodiment except for the parts described below.

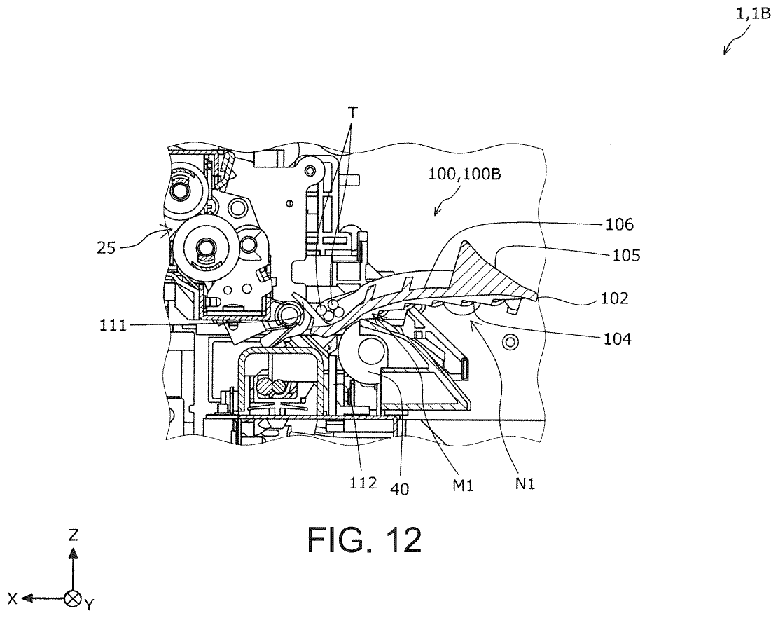

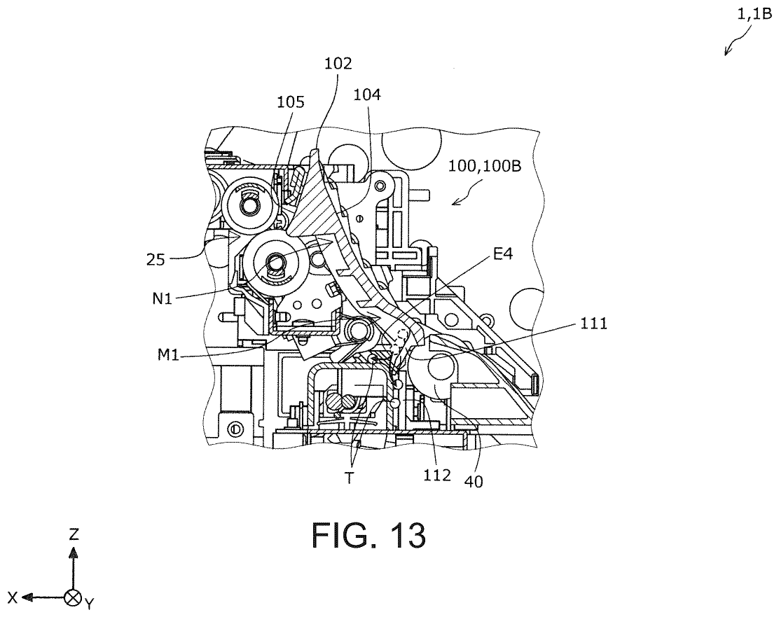

As illustrated in FIGS. 11 to 13, the printer 1B of the present embodiment is provided with ribs 111 in the first facing region M1 on a contact region 105 side of the switching section 100B. As illustrated in FIG. 12, the rib 111 can hold the foreign matter T when the switching section 100B is at the opening position corresponding to the third state. From another viewpoint, the switching section 100B includes the rib 111 as a holding section that holds the foreign matter T in the first facing region M1. When the switching section 100B is at the switching position as illustrated in FIG. 13, the rib 111 is positioned between the driven roller 40 as the first transport roller and the first facing region M1.

With this configuration, the printer 1B of the present embodiment can hold the foreign matter T by the rib 111 as the holding section in a case where the through hole H is not provided in the first facing region M1. In addition, when the switching section 100B returns to the switching position as illustrated in FIG. 13, the foreign matters T move in directions of arrow E4, and a configuration in which the rib 111 and the driven roller 40 overlap each other, in other words, a configuration in which a back side of a region of the rib 111 that holds the foreign matters T faces the driven roller 40 can be adopted. Therefore, it is possible to suppress the foreign matters T held by the rib 111 from depositing to the driven roller 40.

As illustrated in FIG. 11, the printer 1B of the present embodiment includes the through hole H in the first non-facing region N1. However, the effect of suppressing the foreign matter T held by the holding section from depositing to the first transport roller is obtained even in a configuration in which the through hole H is not provided as long as the holding section that holds the foreign matter T is provided in the first facing region M1 and the holding section is positioned between the first transport roller and the first facing region M1 when the switching section is positioned at the switching position. Since there is the effect of suppressing the foreign matter T held by the holding section from depositing to the first transport roller, it is possible to suppress scattering of the foreign matter T depositing to the switching section in the device. The holding section may be configured to hold the foreign matter T so that the foreign matter T does not substantially completely fall, or may be configured to hold the foreign matter T so that the foreign matter T does not fall to a place where the foreign matter T is not desired to fall and to allow the foreign matter T to fall to a place where the foreign matter T is allowed to fall.

As illustrated in FIG. 11, the ribs 111 as the holding sections are provided in the vicinity of a central section of the switching section 100B in the Y-axis direction corresponding to the width direction intersecting the transport direction of the medium P in the printer 1B. In the present embodiment, the driven roller 40 is provided in the vicinity of a central section of the medium P in the width direction. That is, the rib 111 as the holding section is provided over the entire width of the driven roller 40 in the width direction of the medium P. By configuring the printer 1B in this manner, it is possible to suppress falling of the foreign matter T over the entire width direction of the driven roller 40, and thus it is possible to effectively suppress the foreign matter T from depositing to the driven roller 40. In a configuration in which the holding section is provided over the entire width of the first transport roller in the width direction of the medium P, if the first transport roller is divided into a plurality of rollers, individual holding sections may be provided corresponding to each roller and each holding section may cover each roller, or one holding section may cover all the rollers.

On the other hand, the holding section may be provided over the entire switching section 100 in the width direction of the medium P. With such a configuration, the foreign matter T can be held over the entire width direction of the switching section 100, and thus the foreign matter T can be effectively suppressed from depositing to the first transport roller.

As illustrated in FIGS. 12 and 13, the printer 1B is provided with a wall section 112 on a +X direction side of the driven roller 40. In other words, the printer 1B includes the wall section 112 as a protection section that protects the driven roller 40. Here, as illustrated in FIG. 13, when the switching section 100B is at the switching position, the rib 111 and the wall section 112 are positioned between the driven roller 40 and the first facing region M1, and a distal end section of the wall section 112 overlaps a distal end section of the rib 111 in a direction (lower right direction in FIG. 13) when the driven roller 40 is viewed from the first facing region M1. By configuring the printer 1B in this manner, it is possible to effectively suppress deposit of the foreign matter T to the driven roller 40 by the wall section 112 and the rib 111.

### Third Embodiment

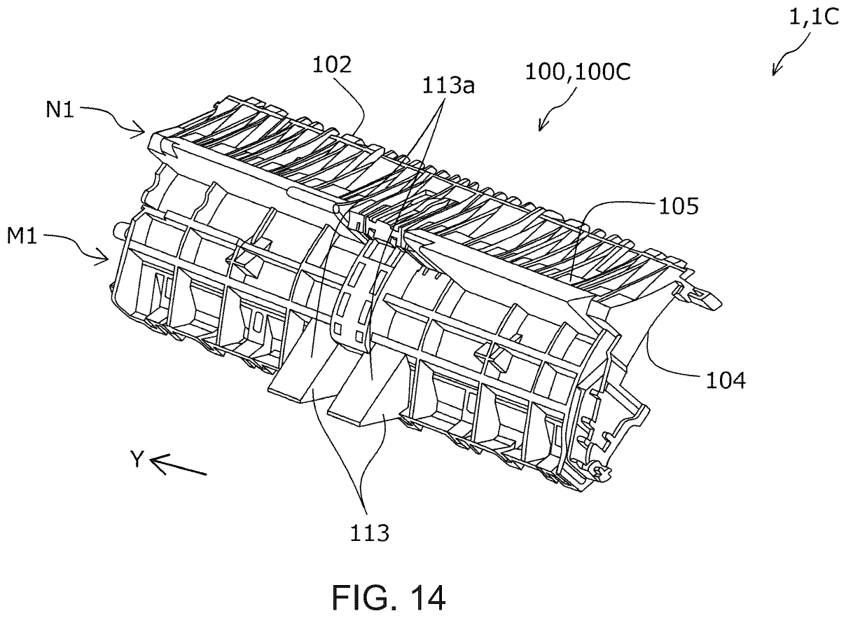

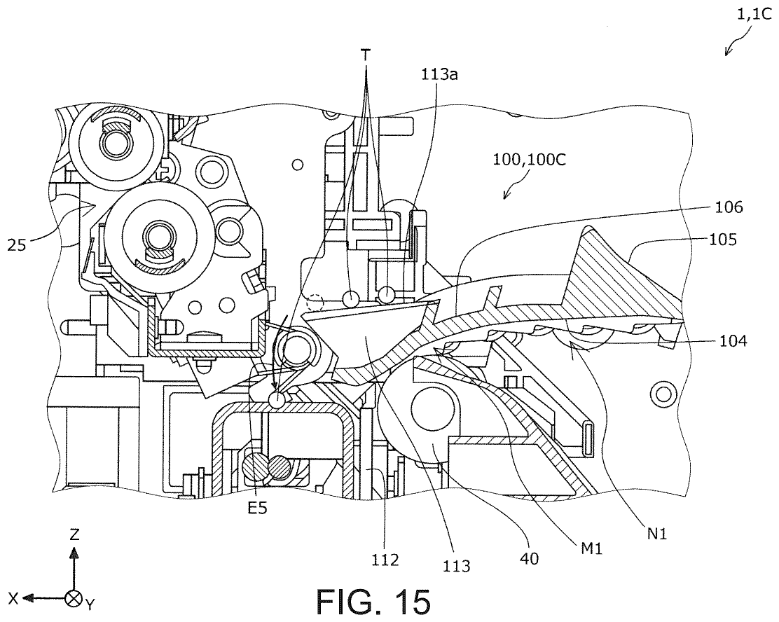

Next, a printer 1C as a medium transport device and a recording device of a third embodiment will be described with reference to FIGS. 14 and 15. In FIGS. 14 and 15, the same reference symbols are given to the same constituent members as those in the first embodiment and the second embodiment, and the detailed description thereof will be omitted. Here, the printer 1C of the present embodiment includes the same configuration as the printer 1 of the first embodiment and the second embodiment except for a configuration of a switching section 100 (switching section 100C) described below. Therefore, the printer 1C of the present embodiment has the same features as the printer 1 of the first embodiment and the second embodiment except for the parts described below.

As described above, in the printer 1B of the second embodiment, the holding section provided on the switching section 100B is the rib 111. On the other hand, in the printer 1C of the present embodiment, as illustrated in FIGS. 14 and 15, the switching section 100C includes holding sections 113 in which upper surfaces 113a facing upward at the opening position of the first facing region M1 are flat surfaces. In other words, when the switching section 100C is at the opening position, a surface of the first facing region M1 that faces upward (the upper surface 113a) is a flat surface. By configuring the printer 1C in this manner, it is possible to cause the foreign matter T on the upper surface 113a to intentionally fall to a place where the foreign matter T may fall as indicated by arrow E5 in FIG. 15, and it is possible to suppress the foreign matter T from being accumulated on the first facing region M1 in a case where the through hole H is not provided in the first facing region M1.

The upper surface 113a may be a horizontal surface or may not be a horizontal surface when the switching section 100C is at the opening position corresponding to the third state, and may be formed by being attached later so as to fill the ribs C or may be molded as a flat surface from the beginning. In a case where the upper surface 113a is not a horizontal surface as in the printer 1C of the present embodiment, the foreign matter T is easily moved in a desired direction such as a direction away from the driven roller 40 by inclining the upper surface 113a in a desired direction.

The present disclosure is not limited to the embodiments described above, and various modifications are possible within the scope of the application described in the claims, and it goes without saying that these are also included within the scope of the present disclosure. For example, the medium transport device is not limited to a printer. For example, the present disclosure may be applied to a medium transport device in a scanner, an intermediate unit provided between various devices, a finisher, or the like.

What is claimed is:

1. A medium transport device comprising:
a switching part that switches a transport direction of a medium in a transport path and
a door part that is configured to open and close with respect to an opening section, and that is configured to be displaced between a closed state in which the door part covers the switching part by closing the opening section and an opened state in which the door part exposes the switching part as viewed from the opening section by opening the opening section, wherein
the switching part is displaced to a switching position where the switching part switches the transport direction of the medium when the door part is in the closed state, and is displaced to an opening position where the switching part opens the transport path when the door part is in the opened state and
a through hole is formed in the switching part.

2. The medium transport device according to claim 1, wherein
the switching part includes a rib across which the medium slides and
the through hole is formed outside the rib with respect to a center in a width direction intersecting the transport direction of the medium.

3. The medium transport device according to claim 1, wherein
the through hole has a shape in which a longitudinal direction is along the transport direction of the medium.

4. The medium transport device according to claim 1, further comprising:
a first transport roller that transports the medium, wherein
the switching part includes a first facing region that faces the first transport roller above the first transport roller at the opening position, and a first non-facing region that does not face the first transport roller above the first transport roller at the opening position and
the through hole is formed in the first non-facing region.

5. The medium transport device according to claim 4, wherein
the switching part includes a holding section that holds foreign matter in the first facing region and
the holding section is positioned between the first transport roller and the first facing region when the switching part is positioned at the switching position.

6. The medium transport device according to claim 5, wherein
the holding section is provided across the entire switching part in a width direction intersecting the transport direction of the medium.

7. The medium transport device according to claim 5, wherein
the holding section is provided over an entire width of the first transport roller in a width direction intersecting the transport direction of the medium.

8. The medium transport device according to claim 5, further comprising:
a protection section that protects the first transport roller, wherein
the holding section and the protection section are positioned between the first transport roller and the first facing region when the switching part is positioned at the switching position and
the protection section overlaps with the holding section in a direction of viewing the first transport roller from the first facing region.

9. The medium transport device according to claim 4, wherein
when the switching part is at the opening position, a surface of the first facing region that faces upward is defined as an upper surface, and the upper surface is a flat surface.

10. The medium transport device according to claim 1, further comprising:
a separation roller pair that separates sheets of the medium, wherein
the switching part includes a second facing region that faces the separation roller pair at the switching position and a second non-facing region that does not face the separation roller pair at the switching position and
the through hole is formed in the second facing region.

11. A recording device comprising:
the medium transport device according to claim 10 and
a recording section that performs recording on the medium transported by the medium transport device.

12. The recording device according to claim 11, further comprising:
a support section that faces the recording section and that supports the medium on which recording is performed by the recording section, wherein
the support section is configured to be displaced between a facing position where the support section faces the recording section and a separation position where the support section is separated from the recording section and
the support section is positioned above the switching part.

13. The recording device according to claim 12, wherein
the support section includes a transport belt that transports the medium, a cleaning section that cleans the transport belt, and an accommodation section that accommodates foreign matter removed by the cleaning section.

14. A recording device comprising:
the medium transport device according to claim 1 and
a recording section that performs recording on the medium transported by the medium transport device.

15. A recording device comprising:
the medium transport device according to claim 4;
a recording section that performs recording on the medium transported by the medium transport device; and
a second transport roller that transports the medium on which recording is not performed by the recording section, wherein
the first transport roller transports the medium on which recording was performed by the recording section,
the switching part includes a third facing region that faces the second transport roller at the opening position and a third non-facing region that does not face the second transport roller at the opening position, and
the through hole is formed in the third facing region.
